(19) United States
(12) Patent Application Publication
(10) Pub. No.: US 2013/0256281 A1
(43) Pub. Date: Oct. 3, 2013

(54) SOLDER-JET NOZZLE, LASER-SOLDERING TOOL, AND METHOD, FOR LASERSOLDERING HEAD-CONNECTION PADS OF A HEAD-STACK ASSEMBLY FOR A HARD-DISK DRIVE

(71) Applicants: Tatsumi Tsuchiya, Kanagawa (JP); Nobuyuki Hashi, Kanagawa (JP); Yusuke Matsumoto, Kanagawa (JP); Takuya Satoh, Kanagawa (JP)

(72) Inventors: Tatsumi Tsuchiya, Kanagawa (JP); Nobuyuki Hashi, Kanagawa (JP); Yusuke Matsumoto, Kanagawa (JP); Takuya Satoh, Kanagawa (JP)

(21) Appl. No.: 13/436,565

(22) Filed: Mar. 30, 2012

(51) Int. Cl. B23K 26/00

(52) U.S. Cl. 219/121.64; 219/121.63

(57) ABSTRACT

A solder-jet nozzle for laser-soldering head-connection pads of a head-stack assembly (HSA) for a hard-disk drive (HDD). The solder-jet nozzle includes a body, a central duct, and an outer surface of the body. The body includes a tip configured to deliver a solder ball in proximity to head-connection pads of a head-gimbal assembly (HGA) of the HSA. The central duct is configured to convey the solder ball to the tip. The outer surface of the body includes a first portion, and at least a first flat. The first portion substantially coincides with a conical surface of a cone with axis disposed about along the central axis of the body. The first flat, which is parallel to the central axis, is contiguous with the first portion, and intersects the conical surface of the cone. A laser-soldering tool and a method, for laser-soldering head-connection pads of the HSA are also provided.

### TECHNICAL FIELD

Embodiments of the present invention relate to a solder-jet nozzle, and a laser-soldering tool and method utilizing the solder-jet nozzle of the laser-soldering tool for laser-soldering connection pads of a head-stack assembly (HSA) for a hard-disk drive (HDD).

### BACKGROUND

Hard-disk drives (HDDs) have been widely used as data-storage devices of computers and have become indispensable data-storage devices for current computer systems. A HDD includes a magnetic-recording disk for storing data, a head-slider, and an actuator for moving the head-slider to a designated position in proximity with the recording surface of the magnetic-recording disk. A head-gimbal assembly (HGA) includes an elastic suspension that suspends the head-slider in proximity with the recording surface of the magnetic-recording disk. The actuator includes at least one HGA. However, if more than one head-slider is incorporated into the design of the HDD for accessing the recording surfaces on both sides of the magnetic-recording disk, or alternatively, the recording surfaces of a plurality of magnetic-recording disks, the actuator includes a plurality of HGAs ganged together in a head-stack assembly (HSA).

Engineers and scientists engaged in HDD manufacturing and development are interested in manufacturing methods for components of the HDD, such as, the HSA, that are cost effective to meet the rising demands of the marketplace for increased value at low price, with good performance, and high reliability.

### SUMMARY

Embodiments of the present invention include a solder-jet nozzle for laser-soldering head-connection pads of a head-stack assembly (HSA) for a hard-disk drive (HDD). The solder-jet nozzle includes a body, a central duct, and an outer surface of the body. The body includes a tip that is disposed at a distal end of the body and is configured to deliver a solder ball in proximity to the head-connection pads of a head-gimbal assembly (HGA) that is disposed in the HSA. The central duct is disposed on a central axis of the body, and is configured to convey the solder ball to the tip. The outer surface of the body includes a first portion, and at least a first flat. The first portion substantially coincides with portions of a conical surface of a cone, in which an axis of the cone is disposed about along the central axis of the body. The first flat is contiguous with the first portion, is disposed about parallel to the central axis of the body, and intersects the conical surface of the cone. Other embodiments of the present invention include a laser-soldering tool, which includes the solder-jet nozzle, and a method that utilize the solder-jet nozzle of the laser-soldering tool for laser-soldering connection pads of the HSA.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is a plan view depicting a configuration of a hard-disk drive (HDD) that utilizes a head-stack assembly (HSA) that is laser-soldered using apparatus and a method in accordance with embodiments of the present invention.

FIG. 2 is a perspective view depicting a configuration of the HSA of the HDD shown in FIG. 1 that is laser-soldered using apparatus and a method in accordance with embodiments of the present invention.

FIG. 3 is an exploded perspective view depicting a configuration of a head-gimbal assembly (HGA), which is a component part of the HSA shown in FIG. 2, that includes a head-slider and a lead-suspension that include head-connection pads that are laser-soldered together using apparatus and a method in accordance with embodiments of the present invention.

FIG. 4 is a perspective view depicting a configuration of a portion of the HGA shown in FIG. 3 that shows head-connection pads of the head-slider and head-connection pads of the lead-suspension that are laser-soldered together with solder joints that are formed using apparatus and a method in accordance with embodiments of the present invention.

FIGS. 5A through 5D are cross-sectional views of examples of the solder-jet nozzle that is configured for laser-soldering head-connection pads of the HGA disposed in the HSA for use in the HDD shown in FIG. 1, in accordance with embodiments of the present invention.

FIG. 6 is a composite drawing of three perspective views of the example shown in FIG. 5D of the solder-jet nozzle, which depicts, in cascaded enlarging views, details in the structure of the body, the tip, and outer surface of the solder-jet nozzle, in accordance with embodiments of the present invention.

FIG. 7A is a drawing that schematically depicts a laser-soldering tool in laser-soldering operations applied to head-connection pads of the head-slider and lead-suspension shown in FIG. 4 of the HGA in the HSA shown in FIG. 2, in accordance with embodiments of the present invention.

FIG. 7B is a drawing that schematically depicts the laser-soldering tool in further laser-soldering operations applied to opposite-facing-twin head-connection pads of an opposite-facing-twin head-slider and opposite-facing-twin lead-suspension of an opposite-facing-twin HGA that is disposed opposite to the HGA depicted as being laser-soldered in FIG. 7A, in accordance with embodiments of the present invention.

FIG. 8 is an enlarged drawing showing details within the inset box 8 of FIG. 7A that schematically depicts the solder-jet nozzle of the laser-soldering tool in the laser-soldering operation of head-connection pads of the head-slider shown in FIG. 4 to head-connection pads of the lead-suspension shown in FIG. 4 of the HGA in the HSA of FIG. 2, in accordance with embodiments of the present invention.

FIG. 9A is a flowchart of a method including the laser-soldering operations described with FIG. 7A for laser-soldering head-connection pads of the head-slider and lead-suspension shown in FIG. 4 of a HGA in the HSA shown in FIG. 2, in accordance with an embodiment of the present invention.

FIG. 9B is a flowchart of the method including further laser-soldering operations described with FIG. 7B for laser-soldering opposite-facing-twin head-connection pads of the opposite-facing-twin head-slider and opposite-facing-twin lead-suspension of the opposite-facing-twin HGA in the HSA shown in FIG. 2, in accordance with embodiments of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary. Reference numerals may refer to both single components and pluralities of similar components.

### Description of Embodiments of the Present Invention for a Solder-Jet Nozzle, Laser-Soldering Tool, and Method, for Laser-Soldering Head-Connection Pads of a Head-Stack Assembly (HSA) for a Hard-Disk Drive (HDD)

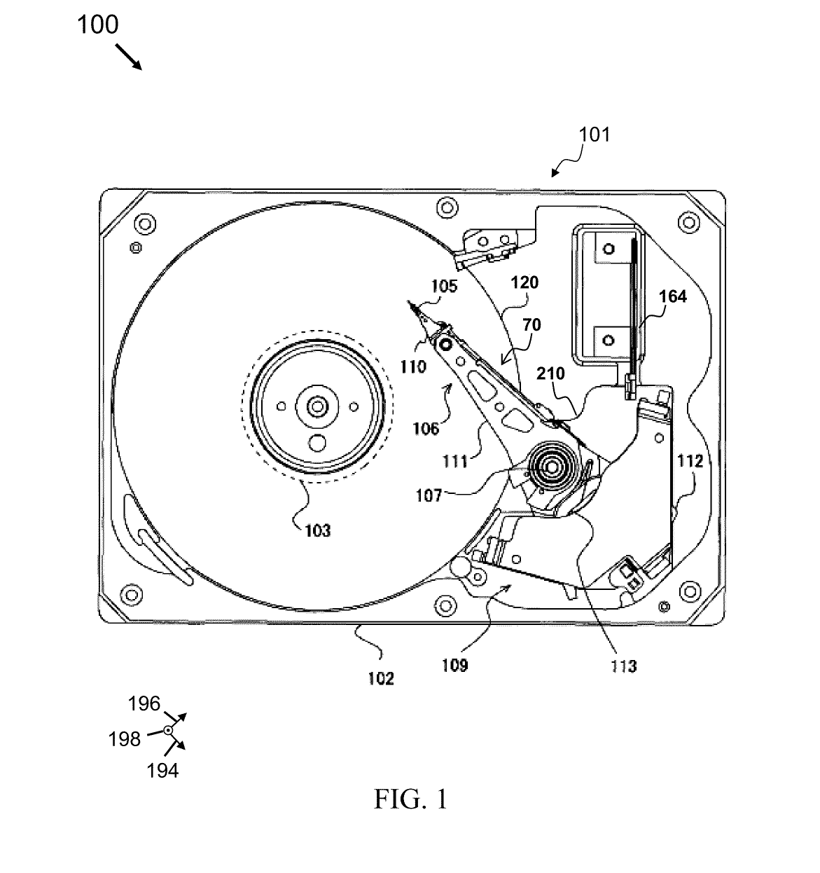

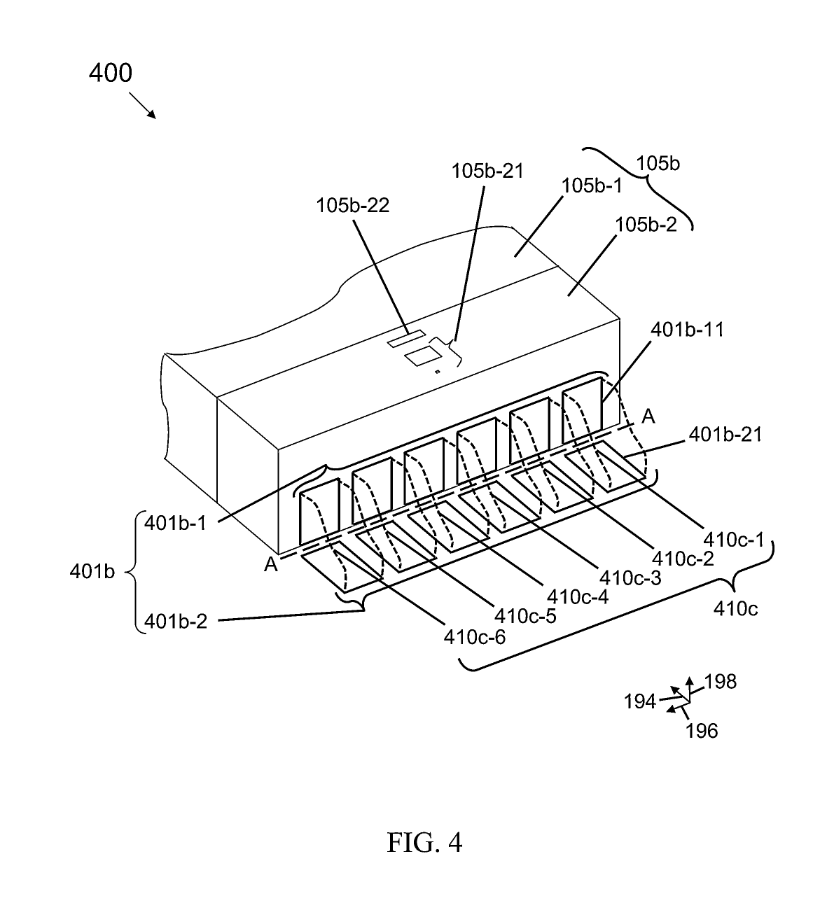

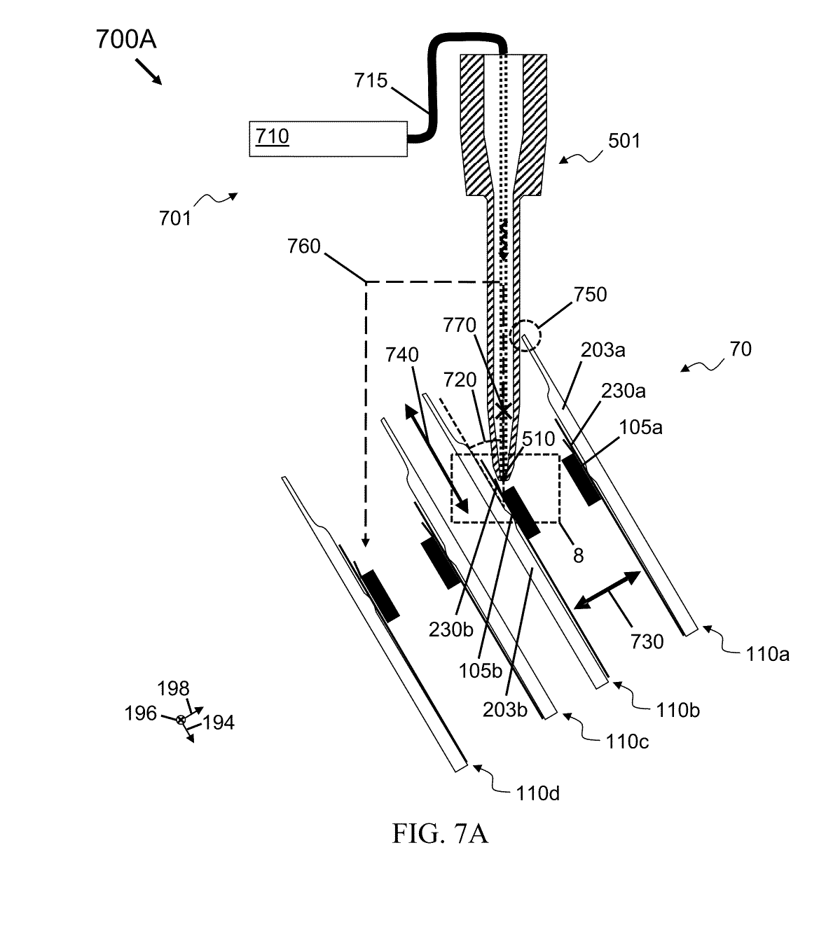

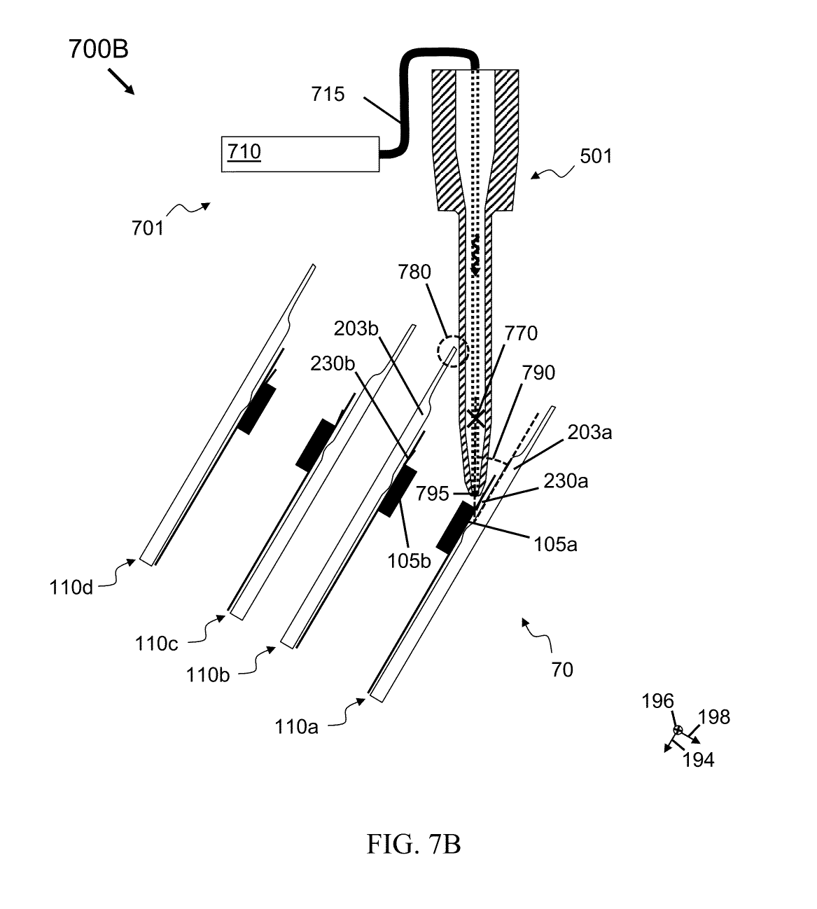

With reference now to FIG. 1, a plan view 100 is shown that depicts a configuration of a hard-disk drive (HDD) 101 that utilizes a head-stack assembly (HSA) 70 that is laser-soldered using apparatus and a method in accordance with embodiments of the present invention. As shown in FIG. 1, mechanical components for HDD 101 are housed in a base 102 of a disk enclosure. Operations of the components in the base 102 are controlled by a control circuit (not shown) on a circuit board affixed outside the base 102 of the disk enclosure. HDD 101 includes a magnetic-recording disk 120, which is a disk for storing data, and a head-slider 105 for accessing the magnetic-recording disk 120. As used herein, “access” is a term of art that refers to operations in seeking a data track of a magnetic-recording disk 120 and positioning a magnetic-recording head on the data track for both reading data from, and/or writing data to, a magnetic-recording disk 120. The head-slider 105, which is representative of any of the head-sliders of HSA 70, for example, head-slider 105b (see FIGS. 4, 7A, 7B and 8) and opposite-facing-twin head-slider 105a (see FIGS. 7A and 7B) that are subsequently described in greater detail, includes a magnetic-recording head for reading user data from and/or writing user data to the magnetic-recording disk 120, and a slider on which the magnetic-recording head is formed.

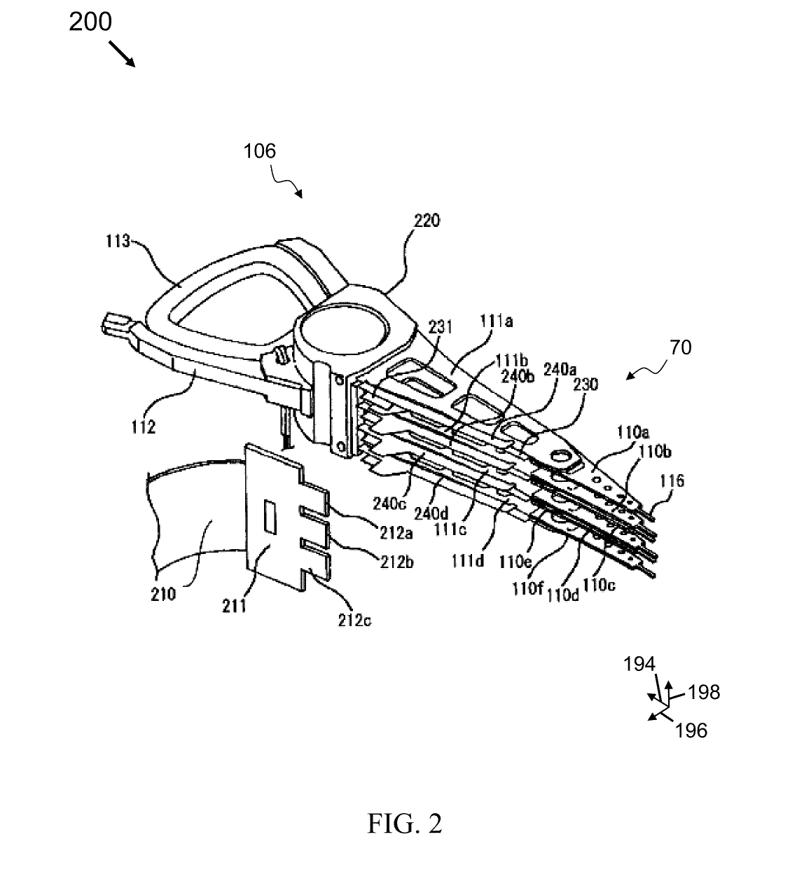

A head-gimbal assembly (HGA) 110 includes an elastic suspension that suspends the head-slider 105 in proximity with the recording surface of the magnetic-recording disk 120. The actuator 106 includes at least one HGA 110. However, if more than one head-slider 105 is incorporated into the design of HDD 101 for accessing the recording surfaces on both sides of the magnetic-recording disk 120, or alternatively, the recording surfaces of a plurality of magnetic-recording disks, the actuator 106 includes a plurality of HGAs ganged together in HSA 70. In order to access the magnetic-recording disk 120, the actuator 106 pivots on a pivot shaft 107 to move the head-slider 105 in proximity with the recording surface of the spinning magnetic-recording disk 120. A voice coil motor (VCM) 109 drives the actuator 106 as a driving mechanism. The actuator 106 includes components of HGA 110, which is representative of any of the HGAs of HSA 70, for example, HGAs 110a-110f that are subsequently described in greater detail (see FIGS. 2, 7A, 7B and 8), an arm 111, a coil yoke 112, and a VCM coil 113 connected in the order recited from the distal end, where the head-slider 105 is disposed in a longitudinal direction of the actuator 106.

A spindle motor (SPM) 103 affixed to the base 102 spins the magnetic-recording disk 120 at a specific angular rate. A force due to pressure caused by air viscosity between an air bearing surface (ABS) of the head-slider 105 facing the magnetic-recording disk 120 and the spinning magnetic-recording disk 120 balances the load applied by HGA 110 to the head-slider 105 in the direction toward the magnetic-recording disk 120 so that the head-slider 105 flies in proximity with the recording surface of the magnetic-recording disk 120.

As shown in FIG. 1, the direction of arrow 196 is about perpendicular to the side of the head-slider 105 lying about parallel to the side of HSA 70 facing the flexible printed circuit (FPC) 210 and the connector block 164 attached to an electrical feed-through situated in the base 102. The direction of arrow 194 is perpendicular to arrow 196 and perpendicular to the side of the head-slider 105 lying about parallel to the side of HSA 70 facing the FPC 210. The direction of arrow 198, which is indicated by the arrow head of arrow 198, is about perpendicular to the plane of the base 102, as well as the plane of the recording surface of the magnetic recording disk 120 and therefore is perpendicular to arrows 194 and 196. Thus, the triad of arrows 194, 196 and 198 are related to one another by the right-hand rule for vectors in the direction of the arrows 194, 196 and 198 such that the cross product of the vector corresponding to arrow 194 and the vector corresponding to arrow 196 produces a vector parallel and oriented in the direction of the arrow 198. The triad of arrows 194, 196 and 198 is subsequently used to indicate the orientation of views for subsequently described drawings of various components of HDD 101, in particular drawings (see FIGS. 2, 7A, and 7B) of HSA 70, which is next described with greater detail in the discussion of FIG. 2.

With reference now to FIG. 2, a perspective view 200 is shown that schematically depicts the structure of the actuator 106 including HSA 70 that is laser-soldered using apparatus and the method in accordance with embodiments of the present invention. As shown in FIG. 2, the triad of arrows 194, 196 and 198 indicates the orientation in which HSA 70 is viewed in perspective view 200 relative to the plan view 100 of FIG. 1. As used herein, the direction along the actuator pivot shaft 107 is defined as an upward-and-downward direction; and, the direction toward the top cover of HDD 101 is defined as upward, and the direction toward the bottom of the base 102 of the DE is defined as downward. Thus, an upward facing portion of a component part of HDD 101 may be referred to herein as a “top” portion of the component part; and, a downward facing portion of a component part of HDD 101 may be referred to herein as a “bottom” portion of the component part. For example, magnetic recording disk 120 has a top magnetic-recording surface, and a bottom magnetic recording surface. Similarly, a head-slider facing a top magnetic-recording surface of magnetic recording disk 120 is referred to herein as a “top” head-slider; and, a head-slider facing a bottom magnetic-recording surface of magnetic recording disk 120 is referred to herein as a “bottom” head-slider. In the actuator 106, the direction toward HGA 110 when viewed from the pivot shaft 107 is defined as frontward; and, the opposite direction is defined as rearward. As used herein, a frontward facing portion of a component part of HDD 101 may be referred to herein as a “trailing edge” portion of the component part; and, a rearward facing portion of a component part of HDD 101 may be referred to herein as a “leading edge” portion of the component part.

The HSA 70 exemplified in FIG. 2 includes a structure applicable to three magnetic-recording disks 120 that include recording surfaces on both sides of each magnetic-recording disk, for example, magnetic-recording disk 120. Each HGA of a pair of HGAs, which are disposed in HSA 70, may face opposite sides of the same magnetic-recording disk. As used herein, the term of art, “opposite-facing-twin,” as in “opposite-facing-twin HGA,” refers to a HGA that is a member of a pair of HGAs in which each HGA of the pair faces a side opposite to a side of a magnetic-recording disk 120 that is faced by the other member of the pair, and to component parts of a HGA that are part of a HGA that faces the opposite side of a magnetic-recording disk 120 to a side of the magnetic-recording disk 120 that is faced by the other HGA of the pair. Thus, “opposite-facing-twin” is a relative term, as, for example, a top head-slider is an opposite-facing-twin head-slider to a bottom head-slider, and a bottom head-slider is an opposite-facing-twin head-slider to a top head-slider. As used herein, by way of example for convenience and consistency of description, top head-sliders are referred to as opposite-facing-twin head-sliders, without limitation thereto, as bottom head-sliders, which are opposite-facing-twin head-sliders to head-sliders that are top head sliders, are also within the spirit and scope of embodiments of the present invention.

The actuator 106 includes four arms 111a-111d and six HGAs 110a-110f which are disposed so as to be stacked when viewed in the direction of the pivot axis. In subsequent descriptions of HSA 70, HSA 70 may be shown with fewer than the six HGAs 110a-110f in the interest of simplifying the discussion. However, the number of HGAs shown is by way of example, as different numbers of HGAs within an HSA are within the spirit and scope of embodiments of the present invention. To an uppermost arm 111a and a lowermost arm 111d, opposite-facing-twin HGA 110a and HGA 110f are secured, respectively. To the respective surfaces of the middle arm 111b, the HGA 110b and opposite-facing-twin HGA 110c are secured, and to the respective surfaces of the middle arm 111c, the HGA 110d and opposite-facing-twin HGA 110e are secured. HSA 70 includes HGAs 110a-110f and the respective arms 111a-111d to which HGAs 110a-110f are secured. The plurality of arms 111a-111d is secured to the carriage 220 of the actuator 106 as a ganged array of the stack in HSA 70. As used herein, the term of art, “actuator,” refers to the component including HSA 70, the carriage 220, the yoke 112, and the voice coil 113. However, it may be noted that, with recent advances in manufacturing, actuators may include a carriage integrated in a single unitary body with the arms and yoke, so that reference to the actuator including HGAs, as an HSA, is also within the spirit and scope of embodiments of the present invention.

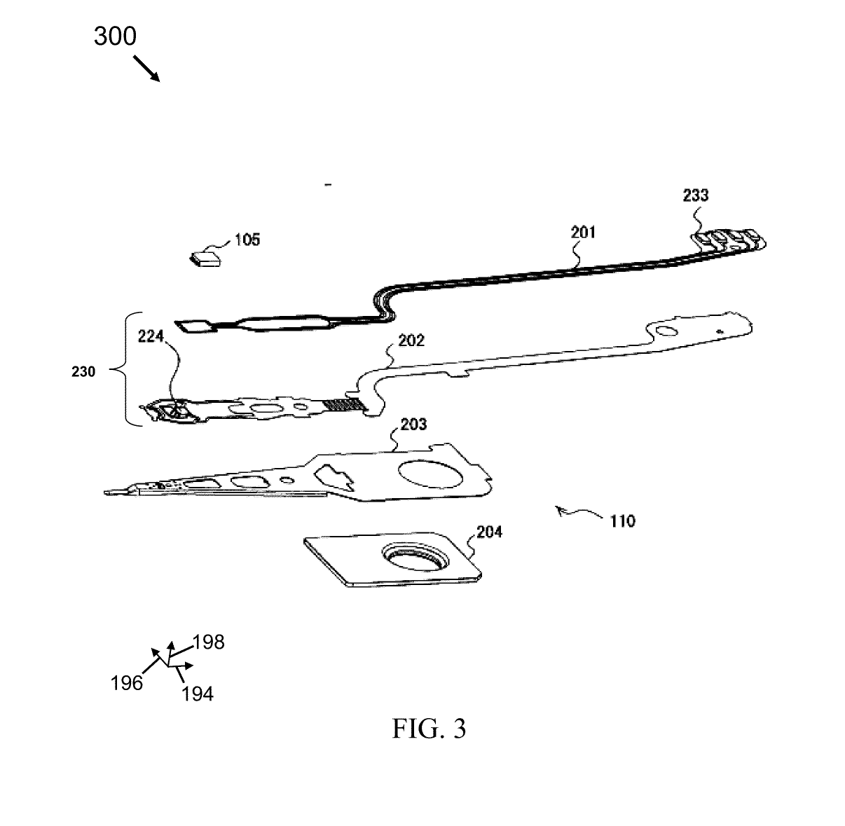

Portions of a wiring and support structure, which is referred to herein as a lead-suspension 230, is seen extending rearward from the load-beam 203 (see FIG. 3) of opposite-facing-twin HGA 110a. In FIG. 2, only the lead-suspension 230 of opposite-facing-twin HGA 110a is illustratively indicated by a reference numeral. As used herein, lead-suspension 230, load-beam 203, head-slider 105, and HGA 110 may refer to generally a lead-suspension and/or an opposite-facing twin lead-suspension, a load-beam and/or an opposite-facing twin lod-beam, a head-slider and/or an opposite-facing twin head-slider, and a HGA and/or an opposite-facing twin HGA, respectively, of HSA 70. The lead-suspension 230 includes a metal layer and conductive leads sandwiched between insulating layers on the metal layer. One end of the lead-suspension 230 is connected to head-connection pads of a head-slider 105 with head-connection pads of the lead-suspension 230 (not shown in FIG. 2, but see FIG. 4). On the other end of the lead-suspension 230 that is closer to the pivot shaft 107, a connector tab 231, which is a projection extending in a lateral direction, which is a direction vertical to the pivot axis, of the actuator, is provided. The connector tab 231 includes a plurality of connection pads (not shown) on the connector tab 231 to be connected to FPC 210. On the plurality of arms 111a-111d, support portions 240a-240d are provided, respectively; each of the support portions 240a-240d houses and supports a corresponding lead-suspension of a plurality of lead-suspensions, each lead-suspension extending from a corresponding load-beam of a plurality of load-beams of respective HGAs 110a-110f.

In the FPC 210, a plurality of conductive leads is arranged separated from each other, and integrated with an insulating sheet made of polyimide films. The FPC 210 is connected to the lead-suspension 230 to transmit signals between the head-slider 105 and a control circuit (not shown). An end of the FPC 210 is bonded to a base plate, which is secured to the actuator 106. The base plate and the FPC 210 constitute a circuit board 211. On the circuit board 211, an arm electronics (AE) module (not shown) including an amplifier circuit is mounted.

On the front end of the circuit board 211, a plurality of projections 212 are formed and slits are provided between the projections 212. On the surface of each projection 212, a plurality of connection pads is provided that will form solder joints for connecting the circuit board with the lead-suspension 230, upon soldering the connection pads to matching connection pads on a connector tab 231 of a lead-suspension 230. With a connector tab 231 of a lead-suspension 230 inserted into a slit, the connection pads on the projection 212 and the connection pads formed on the connector tab 231 are interconnected by soldering.

With reference now to FIG. 3, an exploded perspective view 300 is shown that shows components of HGA 110 of HSA 70, which is representative of any of the HGAs, for example, HGAs 110a-110f that are shown in FIGS. 2, 7A, 7B and 8. Components of HGA 110 include a head-slider 105 and a lead-suspension 230 that include head-connection pads that are laser-soldered using apparatus and the method in accordance with embodiments of the present invention. As shown in FIG. 3, the triad of arrows 194, 196 and 198 indicates the orientation in which HGA 110 is viewed in perspective view 300 relative to the perspective view 200 of FIG. 2. HGA 110 includes leads 201, a suspension 202, a load-beam 203, a mounting plate 204, and the head-slider 105. A lead-suspension 230 includes the leads 201 and the suspension 202, which includes a metal layer. In one embodiment of the present invention, the suspension 202 and the leads 201 of the lead-suspension 230 may be formed integrally to provide an integrated lead-suspension (ILS). The load-beam 203 is made of, for example, stainless steel in the form of a precision cantilever. The stiffness of the load-beam 203 is higher than that of the suspension 202. The load-beam 203 generates a load on the head-slider 105, because of the elastic properties of the load-beam 203. The mounting plate 204 and the suspension 202 are made of, for example, stainless steel. The suspension 202 includes a gimbal 224 to which the head-slider 105 is affixed. The gimbal 224, which is supported elastically, holds the head-slider 105 and tilts freely to contribute to attitude control of the head-slider 105.

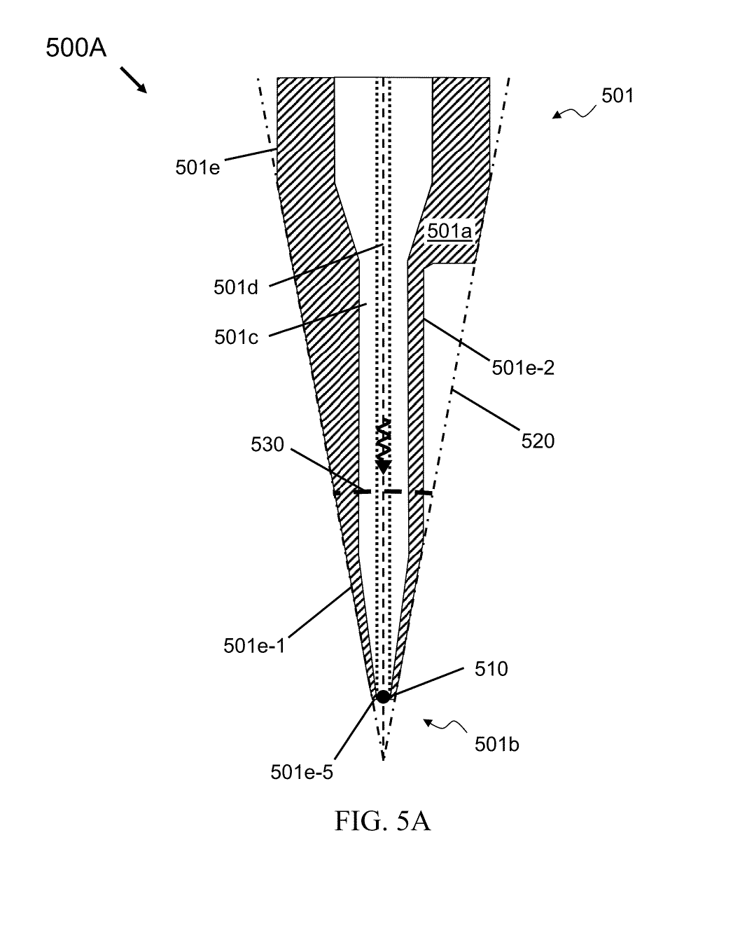

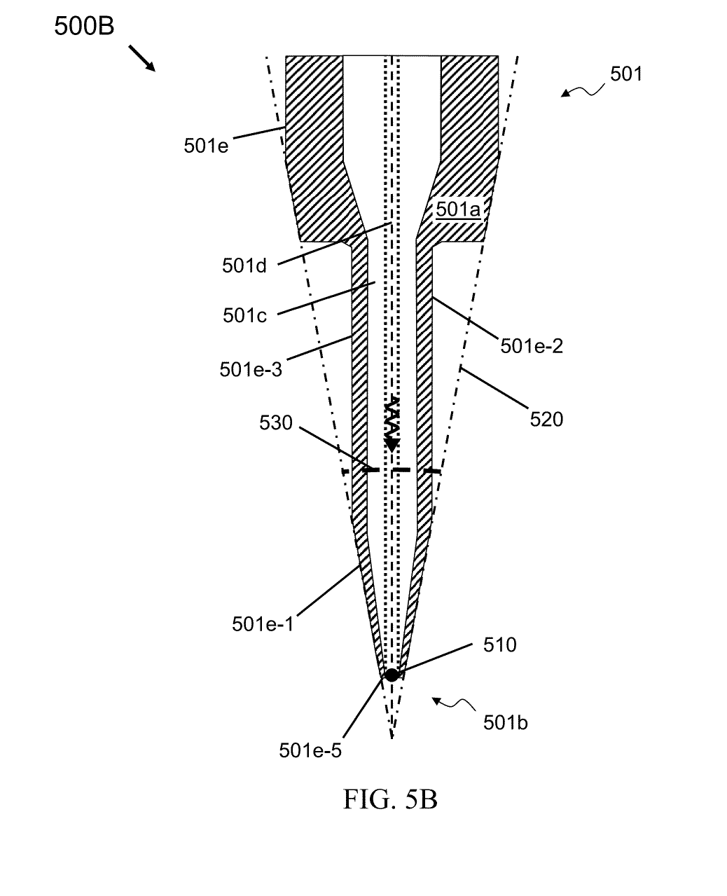

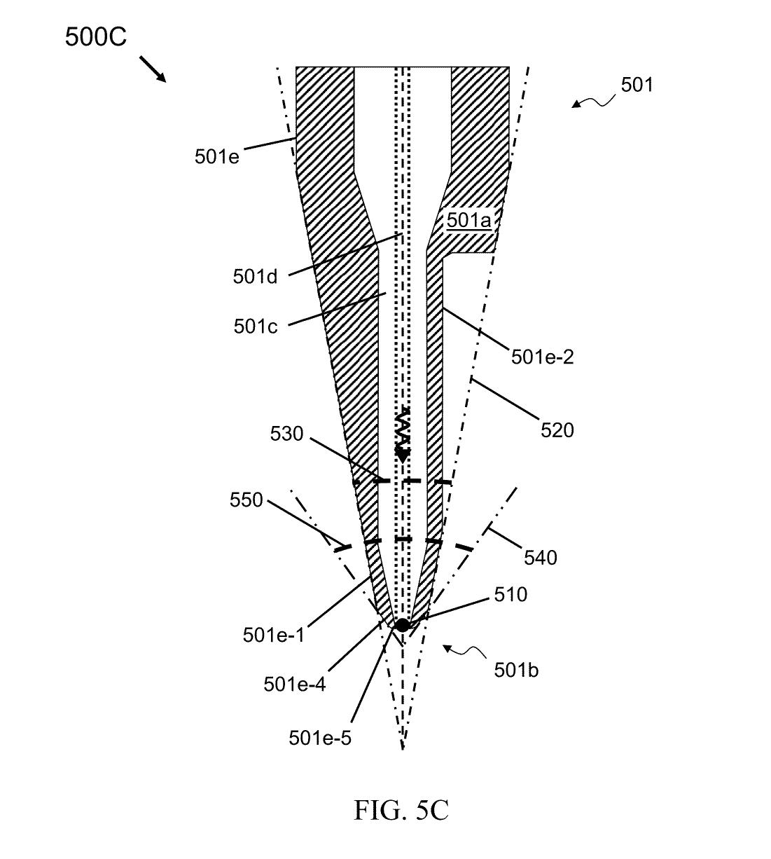

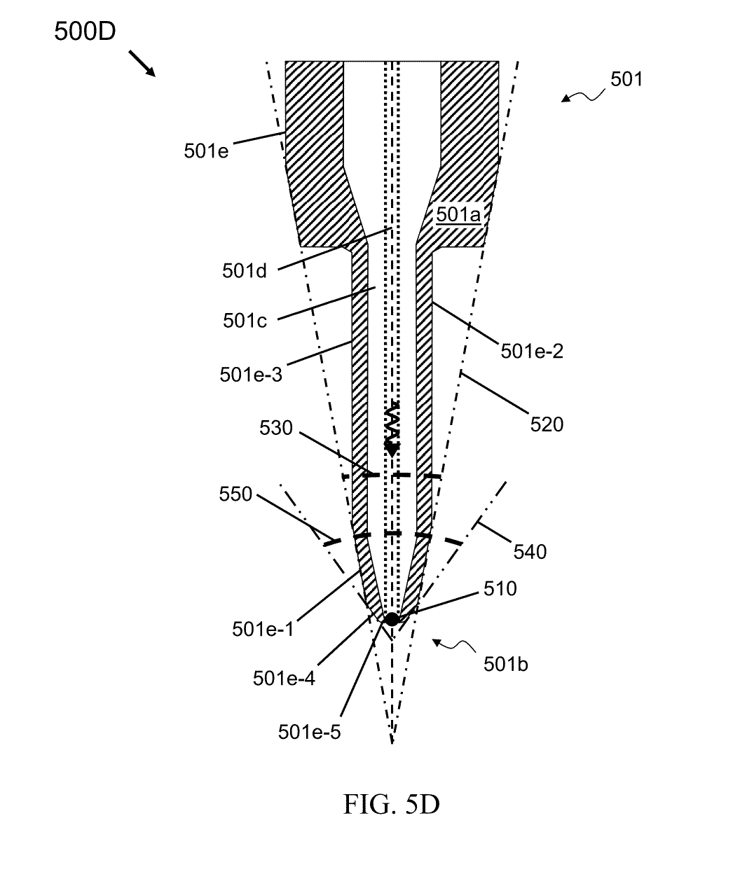

With reference now to FIG. 4, an enlarged perspective view 400 is shown that schematically depicts a head-slider portion of HGA 110b disposed in HSA 70 that is laser-soldered together with solder joints that are formed using apparatus and the method in accordance with embodiments of the present invention. As shown in FIG. 4, the triad of arrows 194, 196 and 198 indicates the orientation in which the head-slider 105b, a bottom head slider, of HGA 110b is viewed in perspective view 400 relative to the perspective view 200 of FIG. 2. FIG. 4 shows in detail a first plurality 401b-1 of head-connection pads, of which head-connection pad 410b-11 is an example, on head-slider 105b at the trailing edge of the head-slider 105b in communication with a second plurality 401b-2 of head-connection pads, of which head-connection pad 410b-21 is an example, on a lead-suspension 230b joined together in pairs by a plurality 401c of solder joints, of which solder joints 410c-1-410c-6 are examples. A line on either side of which the first plurality 401b-1 of head-connection pads on head-slider 105b and the second plurality 401b-2 of head-connection pads on the lead-suspension 230b are about symmetrically arranged for interconnection is indicated by the dashed line A-A. Line A-A defines the joint between the first plurality 401b-1 of head-connection pads on head-slider 105b and the second plurality 401b-2 of head-connection pads on the lead-suspension 230b. As shown in FIG. 4, the head-slider 105b includes a slider 105b-1, a magnetic-recording head 105b-2 coupled with the slider 105b-1, and the first plurality 401b-1 of head-connection pads, of which head-connection pad 410b-11 is an example, on head-slider 105b. The magnetic-recording head 105b-2 includes a write element 105b-21 configured for writing data to a magnetic-recording disk 120, and a read element 105b-22 configured for reading data from the magnetic-recording disk 120. The magnetic-recording head 105b-2 is disposed at a trailing-edge portion of the head-slider 105b. As shown in FIG. 4, the first plurality 401b-1 of head-connection pads on head-slider 105b is disposed on a trailing-edge side of the head-slider 105b. In accordance with embodiments of the present invention, the first plurality 401b-1 of head-connection pads on head-slider 105b is coupled respectively with the second plurality 401b-2 of head-connection pads on the lead-suspension 230b by the plurality 401c of respective solder joints 410c-1-410c-6 through a laser-soldering operation performed on HSA 70 that relies on the use of a solder-jet nozzle 501, the structure of which is next described in greater detail in the discussion of FIGS. 5A through 5D.

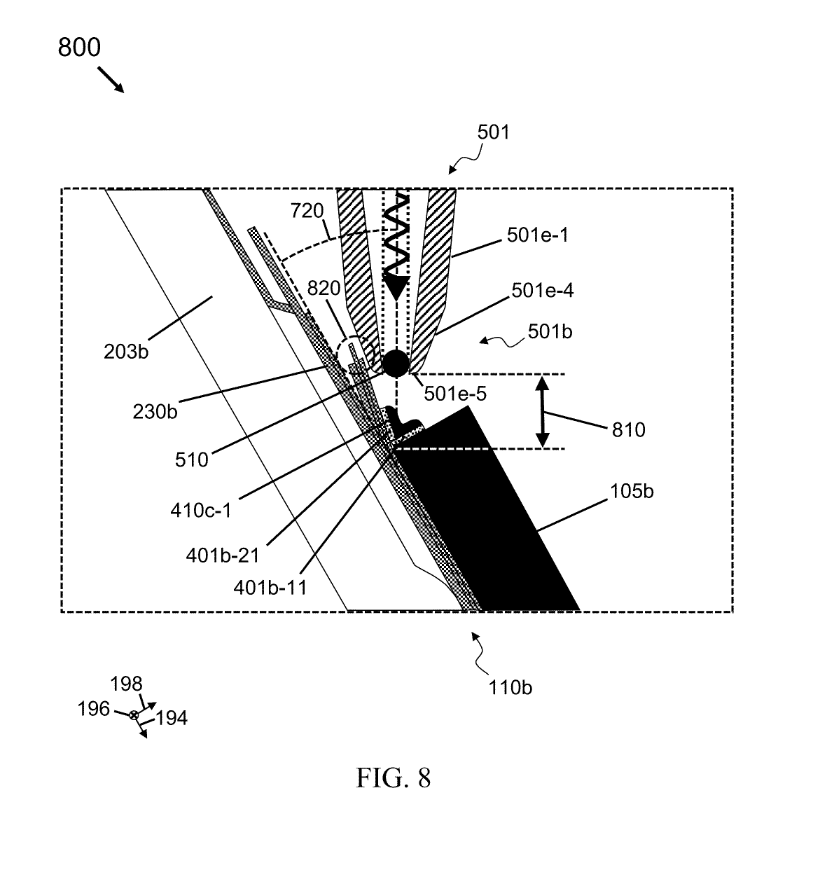

With reference now to FIGS. 5A through 5D, in accordance with embodiments of the present invention, cross-sectional views 500A-500D are shown of examples of the solder-jet nozzle 501 that is configured for laser-soldering head-connection pads of a HGA 110 while disposed in HSA 70 for use in HDD 101. As shown in the cross-sectional view 500A of FIG. 5A, the solder-jet nozzle 501 includes a body 501a, a central duct 501c, and an outer surface 501e of the body 501a. The body 501a includes a tip 501b that is disposed at a distal end of the body 501a and is configured to deliver a solder ball 510 in proximity to the head-connection pads of a HGA 110, of which HGA 110b is an example, that is disposed in HSA 70 (see FIGS. 7A, 7B and 8). By way of example, the solder ball may have a diameter less than or equal to about 80 micrometers (μm), without limitation thereto. As further shown in FIG. 5A, the central duct 501c is disposed on a central axis 501d of the body 501a, and is configured to convey the solder ball 510 to the tip 501b. Thus, in accordance with embodiments of the present invention, the solder-jet nozzle 501 may include a capillary tube configured to transport the solder ball 510 in proximity to head-connection pads 401b of HGA 110, of which HGA 110b is an example, which is disposed in HSA 70. As indicated by the pair of dotted lines disposed about parallel to the central axis 501d of the body 501a, a paraxial ray of a beam of light from a laser 710 (see FIGS. 7A and 7B) is configured to lie within the central duct 501c and about along the central axis 501d of the body 501a. As shown in FIG. 5A and throughout FIGS. 5B-5D and 7A-8, the beam of light is indicated herein by the symbol for a photon; and, the beam of light from the laser 710 (see FIGS. 7A and 7B) that includes the paraxial ray is indicated herein by the pair of dotted lines disposed about parallel to the central axis 501d of the body 501a.

With further reference to FIG. 5A, in accordance with an embodiment of the present invention, the outer surface 501e of the body 501a includes a first portion 501e-1, and at least a first flat 501e-2. As used herein, the term of art, “flat,” refers to a planar portion of the outer surface 501e of the body 501a of the solder-jet nozzle 501. The first portion 501e-1 substantially coincides with portions of a conical surface 520 of a cone, in which an axis of the cone is disposed about along the central axis 501d of the body 501a. The first flat 501e-2 is contiguous with the first portion 501e-1, is disposed about parallel to the central axis 501d of the body 501a, and intersects the conical surface 520 of the cone. Thus, the first flat 501e-2 interrupts the conical surface 520 of the cone associated with the first portion 501e-1 of the outer surface 501e of the body 501a. An opening angle 530 of the cone may be between about 15 degrees and about 20 degrees. Referring also to FIG. 7A, the first flat 501e-2 is configured to enable the tip 501b of the body 501a to approach the head-connection pads of a HGA 110 in HSA 70, by way of example, head-connection pads 401b of HGA 110b, without limitation thereto, within a distance at which delivery of the solder ball 510 may be made to the head-connection pads, without the body 501a interfering with a load-beam 203 of a HGA 110 in HSA 70, by way of example, opposite-facing-twin load-beam 203a of opposite-facing-twin HGA 110a, without limitation thereto. Thus, referring again to FIG. 7A, the first flat 501e-2 is also disposed to allow orientation of the solder-jet nozzle 501 at an upper limit of a grazing angle 720, which is measured between a head-slider side of a lead-suspension 230 of a HGA 110, by way of example, the head-slider side, associated with head-slider 105b, of the lead-suspension 230b of HGA 110b, without limitation thereto, and the central axis 501d of the body 501a. The upper limit of the grazing angle 720 is greater than a lesser upper limit of a lesser grazing angle of a first-flat-less solder-jet nozzle (not shown) without the first flat 501e-2. As used herein, the term of art, “first-flat-less solder-jet nozzle,” refers to a solder jet nozzle with essentially the same structure as the solder-jet nozzle 501, but without the first flat 501e-2. The first flat 501e-2 is configured to enable the tip 501b of the body 501a to approach the head-connection pads 401b more closely than the tip 501b of first-flat-less solder-jet nozzle (not shown) without the first flat 501e-2. Thus, a first-flat-less solder-jet nozzle interferes with the opposite-facing-twin load-beam, by way of example, opposite-facing-twin load-beam 203a (see FIG. 7A), because material of the body 501a is present where a notch would otherwise be created in the body 501a of the solder-jet nozzle 501 by the first flat 501e-2 to accommodate the presence of the opposite-facing-twin load-beam.

With reference now to FIG. 5B, in accordance with another embodiment of the present invention, a cross-sectional view 500B is shown of another example of solder-jet nozzle 501. The outer surface 501e of the body 501a may further include a second flat 501e-3 disposed on an opposite side of the body 501a to where the first flat 501e-2 is disposed. The second flat 501e-3 is also contiguous with the first portion 501e-1, is also disposed about parallel to the central axis 501d of the body 501a, and also intersects the conical surface 520 of the cone. The second flat 501e-3 may be disposed about parallel to the first flat 501e-2. Referring also to FIG. 7B, the second flat 501e-3 is configured to enable the tip 501b of the body 501a to approach the head-connection pads of a HGA 110 in HSA 70, by way of example, opposite-facing-twin head-connection pads of opposite-facing-twin HGA 110a, without limitation thereto, within a distance at which delivery of an other solder ball 795 may be made to the head-connection pads without the body 501a interfering with a load-beam 203 of a HGA 110 in HSA 70, by way of example, load-beam 203b of HGA 110b, without limitation thereto. Thus, referring again to FIG. 7B, the second flat 501e-3 is also disposed to allow orientation of the solder-jet nozzle 501 at an upper limit of a second grazing angle 790, which is measured between a head-slider side of a lead-suspension 230 of a HGA 110, by way of example, the head-slider side, associated with opposite-facing-twin head-slider 105a, of the opposite-facing-twin lead-suspension 230a of opposite-facing-twin HGA 110a, without limitation thereto, and the central axis 501d of the body 501a. The upper limit of the second grazing angle 790 is greater than a lesser upper limit of a lesser second grazing angle of a second-flat-less solder-jet nozzle (not shown) without the second flat 501e-3. As used herein, the term of art, “second-flat-less solder-jet nozzle,” refers to a solder jet nozzle with essentially the same structure as the solder-jet nozzle 501, but without the second flat 501e-3. The second flat 501e-3 is configured to enable the tip 501b of the body 501a to approach the opposite-facing-twin head-connection pads more closely than the tip 501b of second-flat-less solder-jet nozzle (not shown) without the second flat 501e-3. Thus, the second-flat-less solder-jet nozzle interferes with the load-beam, by way of example, load-beam 203b (see FIG. 7B), because material of the body 501a is present where a notch would otherwise be created in the body 501a of the solder-jet nozzle 501 by the second flat 501e-3 to accommodate the presence of the load-beam.

With reference now to FIG. 5C, in accordance with yet another embodiment of the present invention, cross-sectional view 500C is shown of another example of solder-jet nozzle 501. As shown in FIG. 5C, the outer surface 501e of the body 501a may further include a second portion 501e-4 defining at least a portion of an outer surface of the tip 501b. The second portion 501e-4 substantially coincides with portions of a second conical surface 540 of a second cone, in which an axis of the second cone is disposed about along the central axis 501d of the body 501a. The second cone has a second opening angle 550 greater than an opening angle 530 of the cone associated with the first portion 501e-1. A second opening angle 550 of the second cone associated with the second portion 501e-4 may be about 40 degrees. Referring also to FIGS. 7A and 8, the second portion 501e-4 is configured to enable the tip 501b of the body 501a to approach head-connection pads, by way of example, head-connection pads 401b, within a distance 810 at which delivery of the solder ball 510 may be made to the head-connection pads without the tip 501b interfering with a lead-suspension 230 of HGA 110 in HSA 70, by way of example, the lead-suspension 230b of HGA 110b in HSA 70, without limitation thereto. In another embodiment of the present invention, an end surface 501e-5 of the tip 501b may be chamfered. Referring again to FIGS. 7A and 8, the end surface 501e-5 of the tip 501b is configured to enable the end surface 501e-5 of the tip 501b to approach the head-connection pads, by way of example, head-connection pads 401b, within a distance 810 at which delivery of the solder ball 510 may be made to the head-connection pads without the end surface 501e-5 of the tip 501b interfering with the head-connection pads.

With reference now to FIG. 5D, in accordance with still another embodiment of the present invention, cross-sectional view 500D is shown of another example of solder-jet nozzle 501. Similar to FIG. 5B, the outer surface 501e of the body 501a further includes the second flat 501e-3 disposed on the opposite side of the body 501a to where the first flat 501e-2 is disposed, the second flat 501e-3 contiguous with the first portion 501e-1, disposed about parallel to the central axis 501d of the body 501a, and intersecting the conical surface 520 of the cone. Similar to FIG. 5C, the outer surface 501e of the body 501a further includes a second portion 501e-4 defining at least a portion of an outer surface of the tip 501b, the second portion 501e-4 substantially coinciding with portions of a second conical surface 540 of a second cone, an axis of the second cone disposed about along the central axis 501d of the body 501a. Likewise, the second cone has a second opening angle 550 greater than an opening angle 530 of the cone associated with the first portion 501e-1. Similarly, the second opening angle 550 of the second cone associated with the second portion 501e-4 may be about 40 degrees. Similar to FIG. 5C, the end surface 501e-5 of the tip 501b is also chamfered. Thus, in accordance with an embodiment of the present invention, the example of solder-jet nozzle 501 of FIG. 5D includes a combination of the first flat 501e-2, the second flat 501e-3, the second portion 501e-4, and the chamfered end surface 501e-5. The geometrical shapes of the first flat 501e-2, the second flat 501e-3, the second portion 501e-4, and the chamfered end surface 501e-5 are better seen in a perspective drawing, which is next described.

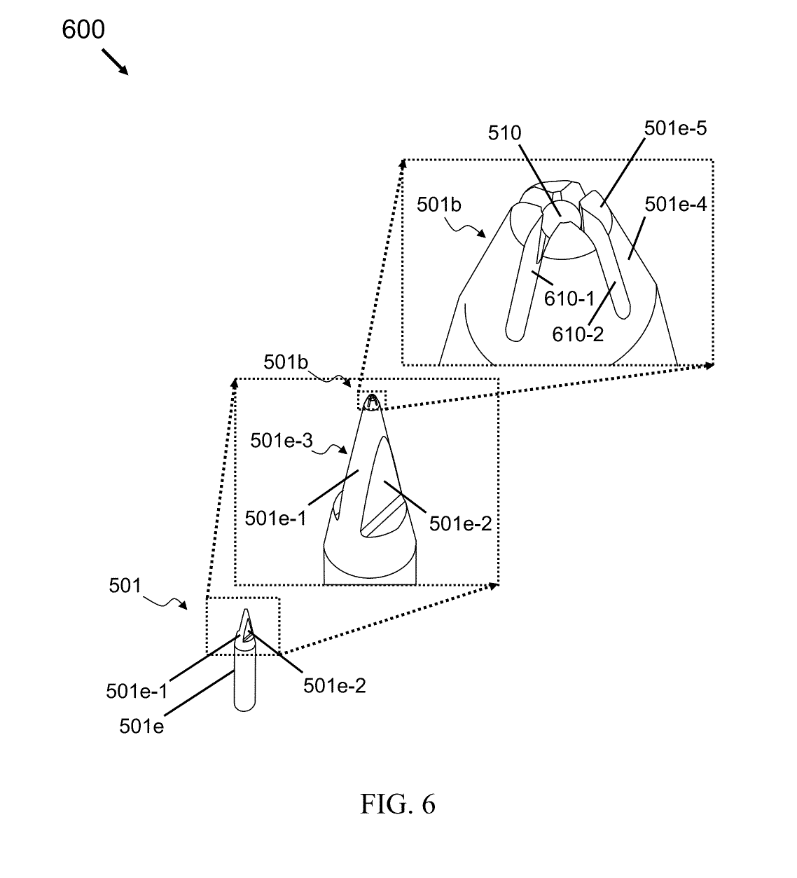

With reference now to FIG. 6, in accordance with embodiments of the present invention, a composite drawing 600 of three perspective views is shown of the example of the solder-jet nozzle 501 shown in cross-section in FIG. 5D. FIG. 6 depicts, in cascaded enlarging views, details of structure of the body 501a, the tip 501b, and outer surface 501e of the solder-jet nozzle 501. As shown in the lower left corner of FIG. 6, at low magnification, the outer surface 501e of the solder-jet nozzle 501 is shown including the first portion 501e-1, which is a substantially conically shaped portion as previously described, and at least the first flat 501e-2 contiguous with the first portion 501e-1, which is a substantially planar portion as previously described. As shown in the middle of FIG. 6, at intermediate magnification, the outer surface 501e of the solder-jet nozzle 501 is shown including the first portion 501e-1, the first flat 501e-2, the second flat 501e-3 contiguous with the first portion 501e-1, which is also a substantially planar portion as previously described, and the tip 501b. As shown in the upper right of FIG. 6, at highest magnification of the three cascaded views, the tip 501b is shown in detail including the second portion 501e-4 of the outer surface 501e, which defines a portion of an outer surface of the tip 501b that is also a substantially conically shaped portion as previously described, the end surface 501e-5 of the tip 501b, which is chamfered as previously described, and a pair of slots 610-1 and 610-2, in between which the solder ball 510 may be disposed. The pair of slots 610-1 and 610-2 is next described in more detail.

With further reference to FIGS. 6 and 4, in accordance with embodiments of the present invention, the tip 501b includes at least one slot 610-1, as described above. Slot 610-1 communicates with the central duct 501c. Slot 610-1 is also disposed about parallel to the central axis 501d of the body 501a. The slot 610-1 is configured to enable melting of the solder ball 510 without vapors from the solder ball 510 substantially deflecting the solder ball 510 from a trajectory directed at the pair of head-connection pads 401b-11 and 401b-21 configured to be joined together in the solder joint 410c-1 formed from the solder ball 510. Similarly, the tip 501b may also include a second slot 610-2. The second slot 610-2 also communicates with the central duct 501c. The second slot 610-2 is also disposed about parallel to the central axis 501d of the body 501a. The second slot 610-2 is also configured to enable melting of the solder ball 510 without vapors from the solder ball 510 substantially deflecting the solder ball 510 from a trajectory directed at the pair of head-connection pads 401b-11 and 401b-21 configured to be joined together in the solder joint 410c-1 formed from the solder ball 510.

With particular reference to FIGS. 5D, 6, 7A and 8, and further reference to FIGS. 3-4, in accordance with embodiments of the present invention, the functionality of the solder-jet nozzle 501 may be summarized as follows, without limitation to the examples described. The first flat 501e-2 is disposed to allow orientation of the solder-jet nozzle 501 at the upper limit of the grazing angle 720, which is measured between a head-slider side of a lead-suspension 230 of HGA 110, by way of example, the head-slider side, associated with bottom head-slider 105b, of the lead-suspension 230b of HGA 110b, without limitation thereto, and the central axis 501d of the body 501a. The first flat 501e-2 is also configured to enable the tip 501b of the body 501a to approach the head-connection pads of HGA 110 in HSA 70, by way of example, head-connection pads 410b of HGA 110b in HSA 70, without limitation thereto, within a distance 810 at which delivery of the solder ball 510 may be made to the head-connection pads without the body 501a interfering with an opposite-facing-twin load-beam 203 of an opposite-facing-twin HGA 110 in HSA 70, by way of example, opposite-facing-twin load-beam 203a of opposite-facing-twin HGA 110a, without limitation thereto. The second portion 501e-4 is configured to enable the tip 501b of the body 501a to approach the head-connection pads, by way of example, head-connection pads 401b, without limitation thereto, within a distance 810 at which delivery of the solder ball 510 may be made to the head-connection pads without the tip 501b interfering with a lead-suspension 230 of HGA 110 in HSA 70, by way of example, lead-suspension 230b of HGA 110b, without limitation thereto. The end surface 501e-5 of the tip 501b is configured to enable the end surface 501e-5 of the tip 501b to approach the head-connection pads, by way of example, head-connection pads 401b, without limitation thereto, within a distance 810 at which delivery of the solder ball 510 may be made to the head-connection pads without the end surface 501e-5 of the tip 501b interfering with the head-connection pads.

With particular reference to FIGS. 5D, 6, 7B and 8, and further reference to FIGS. 3-4, in accordance with embodiments of the present invention, the functionality of the solder-jet nozzle 501 may further be summarized as follows, without limitation to the examples described. The second flat 501e-3 is disposed to allow orientation of the solder-jet nozzle 501 at the upper limit of a second grazing angle 790, which is measured between a head-slider side of an opposite-facing-twin lead-suspension 230 of HGA 110, by way of example, the head-slider side, associated with opposite-facing-twin head-slider 105a, of the opposite-facing-twin lead-suspension 230a of opposite-facing-twin HGA 110a, without limitation thereto, and the central axis 501d of the body 501a. The second flat 501e-3 is configured to enable the tip 501b of the body 501a to approach the opposite-facing-twin head-connection pads of an opposite-facing-twin HGA 110 in HSA 70, by way of example, opposite-facing-twin head-connection pads of opposite-facing-twin HGA 110a, without limitation thereto, within a distance, about the same as the distance 810 shown in FIG. 8, at which delivery of the other solder ball 795 may be made to the opposite-facing-twin head-connection pads of the opposite-facing-twin HGA 110 without the body 501a interfering with a load-beam 203 of HGA 110 in HSA 70, by way of example, load-beam 203b of HGA 110b, without limitation thereto. The second portion 501e-4 is configured to enable the tip 501b of the body 501a to approach the opposite-facing-twin head-connection pads, by way of example, opposite-facing-twin head-connection pads of opposite-facing-twin HGA 110a, without limitation thereto, within a distance, about the same as the distance 810 shown in FIG. 8, at which delivery of the other solder ball 795 may be made to the opposite-facing-twin head-connection pads without the tip 501b interfering with an opposite-facing-twin lead-suspension 230 of opposite-facing-twin HGA 110 in HSA 70, by way of example, opposite-facing-twin lead-suspension 230a of opposite-facing-twin HGA 110a, without limitation thereto. The end surface 501e-5 of the tip 501b is configured to enable the end surface 501e-5 of the tip 501b to approach the opposite-facing-twin head-connection pads, by way of example, opposite-facing-twin head-connection pads of opposite-facing-twin HGA 110a, without limitation thereto, within a distance, about the same as the distance 810 shown in FIG. 8, at which delivery of the solder ball 510 may be made to the opposite-facing-twin head-connection pads without the end surface 501e-5 of the tip 501b interfering with the opposite-facing-twin head-connection pads. The geometrical relationships between the solder-jet nozzle 501 and HSA 70 summarized above may be better appreciated in the following detailed description of embodiments of the present invention aided by FIGS. 7A, 7B and 8.

With reference now to FIG. 7A and further reference to FIGS. 2-6, a drawing 700A is shown that schematically depicts a laser-soldering tool 701 in laser-soldering operations applied to the first plurality 401b-1 of head-connection pads of the head-slider 105b and the second plurality 401b-2 of head-connection pads of the lead-suspension 230b of HGA 110b in HSA 70, using the apparatus and method in accordance with an embodiment of the present invention. As shown in FIG. 7A, the triad of arrows 194, 196 and 198 indicates the orientation in which HSA 70 is viewed in drawing 700A relative to the perspective view 200 of FIG. 2. The laser-soldering tool 701 includes a laser 710, a waveguide 715, and the solder-jet nozzle 501. The laser-soldering tool 701 may also include other components (not shown), such as, by way of example, a laser power supply, fixturing for the solder-jet nozzle, a stage for mounting the HSA 70, an inert gas supply in communication with the central duct 501c of the solder-jet nozzle 501 for ejecting the solder ball 510 from the tip 501b, control electronics for automating the laser-soldering operation, and stepper motors for positioning the solder-jet nozzle 501 relative to the HSA 70, without limitation thereto. The waveguide 715 may be a flexible fiber optic. The laser 710 is configured to melt the solder ball 510 disposed at the tip 501b. A paraxial ray of a beam of light from the laser 710 is configured to lie within the central duct 501c and about along the central axis 501d of the body 501a.

With further reference to FIGS. 2-7A, in accordance with embodiments of the present invention, the previously described embodiments of the present invention for the solder jet nozzle 501 may be incorporated within the environment of the laser-soldering tool 701. Thus, in accordance with embodiments of the present invention, the solder-jet nozzle 501 of the laser-soldering tool 701 includes a body 501a including a tip 501b, a central duct 501c, and an outer surface 501e of the body 501a. The tip 501b is disposed at a distal end of the body 501a configured to deliver the solder ball 510 in proximity to the head-connection pads 401b of a HGA 110b that is disposed in HSA 70. The central duct 501c is disposed along the central axis 501d of the body 501a, and is configured to convey the solder ball 510 to the tip 501b. The outer surface 501e of the body 501a includes a first portion 501e-1 and at least a first flat 501e-2. The first portion 501e-1 substantially coincides with portions of a conical surface 520 of a cone, in which an axis of the cone is disposed about along the central axis 501d of the body 501a. The first flat 501e-2 is contiguous with the first portion 501e-1, is disposed about parallel to the central axis 501d of the body 501a, and intersects the conical surface 520 of the cone. Moreover, as shown in FIG. 7A, the solder-jet nozzle 501 includes the previously described embodiments of the solder jet nozzle described above in the discussion of FIGS. 5D and 6.

With further reference to FIGS. 2-7A and FIG. 8, in accordance with embodiments of the present invention, the solder ball 510 upon melting by the laser 710 is configured to solder together a pair of head-connection pads 401b-11 and 401b-21 of HGA 110b disposed in HSA 70 by forming a solder joint 410c-1 between the pair of head-connection pads 401b-11 and 401b-21. The pair of head-connection pads 401b-11 and 401b-21 includes a head-connection pad 401b-11 of the head-slider 105b and a matching head-connection pad 401b-21 of the lead-suspension 230b. The first flat 501e-2 is disposed to allow orientation of the solder-jet nozzle 501 at an upper limit of a grazing angle 720, measured between a head-slider side of the lead-suspension 230b of HGA 110b and the central axis 501d of the body 501a. The upper limit of the grazing angle 720 is greater than a lesser upper limit of a lesser grazing angle of a first-flat-less solder-jet nozzle (not shown) without the first flat 501e-2. The grazing angle 720 may be equal to or greater than about 30 degrees. The first flat 501e-2 is configured to enable the tip 501b of the body 501a to approach the head-connection pads within a distance 810 at which delivery of the solder ball 510 may be made to the head-connection pads 401b, without the body 501a interfering with the opposite-facing-twin load-beam 203a of the opposite-facing-twin HGA 110a in HSA 70. The circle 750 shows the absence of such interference between the body 501a and the opposite-facing-twin load-beam 203a of the opposite-facing-twin HGA 110a in HSA 70. The first flat 501e-2 is configured to enable the tip 501b of the body 501a to approach the head-connection pads 401b more closely than a tip of a first-flat-less solder-jet nozzle (not shown) without the first flat 501e-2.

With further reference to FIGS. 2-7A, in accordance with an embodiment of the present invention, the lead-suspension 230b of HGA 110b of HSA 70 is disposed about parallel to and opposite to the opposite-facing-twin lead-suspension 230a of opposite-facing-twin HGA 110a of HSA 70. The head-slider 105b of HGA 110b is disposed with its front side, which is a disk-facing side, facing a front side of the opposite-facing-twin head-slider 105a of the opposite-facing-twin HGA 110a. The lead-suspension 230b of HGA 110b is separated by a distance 730 of about 1.2 millimeters (mm) from the opposite-facing-twin lead-suspension 230a of the opposite-facing-twin HGA 110a. The head-slider of HGA 110b is disposed about 2.0 mm behind a distal end of HGA 110b, as measured by the distance 740 from the distal end of HGA 110b to the trailing-edge side of the head-slider 105b. Similarly, the opposite-facing-twin head-slider 105a of the opposite-facing-twin HGA 110a is disposed about 2.0 mm behind the opposite-facing-twin distal end of the opposite-facing-twin HGA 110a, as measured by a distance (not shown), similar to the distance 740, from the distal end of opposite-facing-twin HGA 110a to the trailing-edge side of the opposite-facing-twin head-slider 105a. An inset box 8 is also shown in FIG. 7A that is subsequently used to further describe embodiments of the present invention with the aid of FIG. 8.

With reference now to FIG. 7B and further reference to FIGS. 2-6, a drawing 700B is shown that schematically depicts the laser-soldering tool 701 in laser-soldering operations applied to a third plurality of opposite-facing-twin head-connection pads of the opposite-facing-twin head-slider 105a and a fourth plurality of opposite-facing-twin head-connection pads of the opposite-facing-twin lead-suspension 230a of the opposite-facing-twin HGA 110a that is disposed opposite to HGA 110b in HSA 70, using the apparatus and method in accordance with embodiments of the present invention. As shown in FIGS. 7A and 7B, the opposite-facing-twin HGA 110a is disposed opposite to HGA 110b in HSA 70. As shown in FIG. 7B, the triad of arrows 194, 196 and 198 indicates the orientation in which HSA 70 is viewed in drawing 700B relative to the perspective view 200 of FIG. 2. The outer surface 501e of the body 501a further includes a second flat 501e-3 disposed on the opposite side of the body 501a to where the first flat 501e-2 is disposed, the second flat 501e-3 contiguous with the first portion 501e-1, disposed about parallel to the central axis 501d of the body 501a, and intersecting the conical surface 520 of the cone. The solder-jet nozzle 501 and the laser 710 are configured to solder together the opposite-facing-twin pair of opposite-facing-twin head-connection pads of the opposite-facing-twin HGA 110a disposed in HSA 70 by forming the opposite-facing-twin solder joint between the opposite-facing-twin pair of opposite-facing-twin head-connection pads. Similar to the head-connection pads 401b shown in FIG. 4, the opposite-facing-twin pair of opposite-facing-twin head-connection pads includes the opposite-facing-twin head-connection pad of the third plurality of opposite-facing-twin head-connection pads of the opposite-facing-twin head-slider 105a and a matching opposite-facing-twin head-connection pad of the fourth plurality of opposite-facing-twin head-connection pads on the opposite-facing-twin lead-suspension 230a. The opposite-facing-twin lead-suspension 230a of the opposite-facing-twin HGA 110a is disposed opposite to the lead-suspension 230b of HGA 110b. The second flat 501e-3 is configured to enable the tip 501b of the body 501a to approach the opposite-facing-twin head-connection pads of the opposite-facing-twin HGA 110a in HSA 70 within a distance at which delivery of the other solder ball 795 may be made to the opposite-facing-twin head-connection pads, without the body 501a interfering with the load-beam 203b of HGA 110b in HSA 70. The circle 780 shows the absence of such interference between the body 501a and the load-beam 203b of the HGA 110b in HSA 70. The second flat 501e-3 is configured to enable the tip 501b of the body 501a to approach the opposite-facing-twin head-connection pads more closely than the tip 501b of second-flat-less solder-jet nozzle (not shown) without the second flat 501e-3.

With reference now to FIG. 8 and further reference to FIGS. 7A and 4, in accordance with embodiments of the present invention, an enlarged drawing 800 is shown that illustrates details within inset box 8 of FIG. 7A. FIG. 8 schematically depicts the solder-jet nozzle 501 of the laser-soldering tool 701 for laser-soldering the first plurality 401b-1 of head-connection pads of the head-slider 105b of FIG. 4 to the second plurality 401b-2 of head-connection pads of the lead-suspension 230b of FIG. 4 of HGA 110b in HSA 70, using apparatus and a method in accordance with embodiments of the present invention. As shown in FIG. 8, the triad of arrows 194, 196 and 198 indicates the orientation in which HSA 70 is viewed in the inset box 8 of the drawing 700A detailed in enlarged drawing 800 relative to the perspective view 200 of FIG. 2. The solder-jet nozzle 501 is configured to be disposed at a distance 810 within about 100 microns (μm) of a joint of the head-connection pads 401b, indicated by line A-A in FIG. 4. The solder-jet nozzle 501 and the laser 710 are configured to solder together a pair of head-connection pads 401b-11 and 401b-21 of HGA 110b disposed in HSA 70 by forming the solder joint 410c-1 between the pair of head-connection pads 401b-11 and 401b-21. The pair of head-connection pads 401b-11 and 401b-21 includes the head-connection pad 401b-11 of the first plurality 401b-1 of head-connection pads of the head-slider 105b and a matching head-connection pad 401b-21 of the second plurality 401b-2 of head-connection pads on the lead-suspension 230b. The first flat 501e-2 is configured to enable the tip 501b of the body 501a to approach the head-connection pads within a distance 810 at which delivery of the solder ball 510 may be made to the head-connection pads, without the body 501a interfering with the opposite-facing-twin load-beam 203a of the opposite-facing-twin HGA 110a in HSA 70. Similarly, the second portion 501e-4 is configured to enable the tip 501b of the body 501a to approach the head-connection pads 401b within a distance 810 at which delivery of the solder ball 510 may be made to the head-connection pads 401b, without the tip 501b interfering with the lead-suspension 230b of HGA 110b in HSA 70. The circle 820 shows the absence of such interference between the tip 501b and the lead-suspension 230b of the HGA 110b in HSA 70. The end surface 501e-5 of the tip 501b is chamfered. The end surface 501e-5 of the tip 501b is configured to enable the end surface 501e-5 of the tip 501b to approach the head-connection pads 401b within a distance 810 at which delivery of the solder ball 510 may be made to the head-connection pads 401b, without the end surface 501e-5 of the tip 501b interfering with the head-connection pads 401b.

With further reference to FIGS. 8, 7A and 4, in accordance with embodiments of the present invention, to perform laser-soldering of the head-connection pads 410b of HSA 70, the solder-jet nozzle 501 of the laser-soldering tool 701 is disposed with the central axis 501d of the body 501a of the solder-jet nozzle 501 aligned about parallel to a force field. By way of example, the force field may be the gravitation force field of the Earth, without limitation thereto. A first flat 501e-2 of an outer surface 501e of the body 501a enables the tip 501b of the body 501a of the solder-jet nozzle 501 to approach the pair of head-connection pads 401b-11 and 401b-21 without the body 501a of the solder-jet nozzle 501 interfering with the opposite-facing-twin load-beam 203a of the opposite-facing-twin HGA 110a in HSA 70. Thus, in accordance with embodiments of the present invention, the solder-jet nozzle 501 may be disposed within about 100 microns (μm) of the joint of the head-connection pads, indicated by line A-A in FIG. 4. The lead-suspension 230b of HGA 110b in HSA 70 may be oriented at a grazing angle 720, measured between a head-slider side of the lead-suspension 230b of HGA 110b and the central axis 501d of the body 501a, with the grazing angle 720 being between about 20 degrees and about 30 degrees. Thus, in accordance with embodiments of the present invention, the head-connection pads 401b of HGA 110b in HSA 70 are disposed below the tip 501b of the body 501a of the solder-jet nozzle 501, such that the pair of head-connection pads 401b-11 and 401b-21 are configured to receive the solder ball 510 released from the tip 501b in a molten state. The solder ball 510 at the tip 501b of the solder-jet nozzle 501 is irradiated with a laser 710 of the laser-soldering tool 701 to melt the solder ball 510. Thus, in accordance with embodiments of the present invention, the solder ball 510 may be released in the molten state from the tip 501b to be transported onto the pair of head-connection pads 401b-11 and 401b-21 including a head-connection pad 401b-11 of the first plurality 401b-1 of head-connection pads of a head-slider 105b and a matching head-connection pad 401b-21 of the second plurality 401b-2 of head-connection pads of the lead-suspension 230b. By way of example, as the force field may be the gravitational force field of the Earth, releasing the solder ball 510 in a molten state from the tip 501b may include dropping the solder ball 510, without limitation thereto, in a molten state from the tip 501b to fall onto the pair of head-connection pads 401b-11 and 401b-21. However, in accordance with other embodiments of the present invention, transport of the solder ball 510 in the molten state to the pair of head-connection pads 401b-11 and 401b-21 may be aided by a stream of inert gas blown down the central duct 501c. Thus, in accordance with embodiments of the present invention, the solder joint 410c-1 may be formed between the pair of head-connection pads 401b-11 and 401b-21.

As indicated by the path 760 shown in FIG. 7A for the relative displacement between the solder-jet nozzle 501 of the laser-soldering tool 701 and HSA 70, similar laser-soldering operations may be performed on correspondingly similar head-connection pads of correspondingly similar HGA 110d in HSA 70 after moving the solder-jet nozzle 501 along path 760 into proximity with the correspondingly similar head-connection pads of correspondingly similar HGA 110d. As used herein, the term of art, “correspondingly similar,” as in “correspondingly similar HGA,” refers to another HGA that has the same orientation with respect to a magnetic-recording disk 120 as a reference HGA, and to component parts of the other HGA that have the same orientation with respect to a magnetic-recording disk 120 as component parts in the reference HGA. For example, taking HGA 110b as the reference HGA, HGA 110d stands in the relation of a correspondingly similar HGA to the reference HGA, HGA 110b, as both are HGAs having bottom head-sliders. Similarly, taking opposite-facing-twin HGA 110a as the reference HGA, opposite-facing-twin HGA 110c stands in the relation of a correspondingly similar HGA to the reference HGA, opposite-facing-twin HGA 110a, as both are HGAs with top head-sliders.

With further reference to FIG. 7B, in accordance with embodiments of the present invention, to perform laser-soldering of the opposite-facing-twin head-connection pads of the opposite-facing-twin HGA 110a of HSA 70, the opposite-facing-twin lead-suspension 230a of the opposite-facing-twin HGA 110a of HSA 70 are disposed about parallel to and opposite to the lead-suspension 230b of HGA 110b of HSA 70. A second flat 501e-3 of the outer surface 501e of the body 501a enables the tip 501b of the body 501a to approach opposite-facing-twin head-connection pads within a distance, similar to the distance 810 shown in FIG. 8, at which delivery of the other solder ball 795 may be made to the opposite-facing-twin head-connection pads, without the body 501 a interfering with the load-beam 203b of HGA 110b in HSA 70. The HSA 70 is oriented at a second grazing angle 790, measured between the opposite-facing-twin head-slider side of the opposite-facing-twin lead-suspension 230a of opposite-facing-twin HGA 110a, and the central axis 501d of the body 501a, the second grazing angle 790 being between about 20 degrees and about 30 degrees. By way of example, orientation of HSA 70 may be performed by rotating HSA 70 about an axis 770 of rotation parallel to the direction indicated by arrow 196 that passes through the point indicated by the “X” in FIGS. 7A and 7B, without limitation thereto. Thus, in accordance with embodiments of the present invention, the opposite-facing-twin head-connection pads of the opposite-facing-twin HGA 110a in HSA 70 are placed below the tip 501b of the body 501a of the solder-jet nozzle 501, such that the opposite-facing-twin pair of opposite-facing-twin head-connection pads is configured to receive an other solder ball 795 in the molten state released from the tip 501b. The other solder ball 795 at the tip 501b of the solder-jet nozzle 501 may be irradiated with the laser 710 of the laser-soldering tool 701 to melt the other solder ball 795. Thus, in accordance with embodiments of the present invention, the other solder ball 795 in the molten state may be released from the tip 501b to be transported onto the opposite-facing-twin pair of opposite-facing-twin head-connection pads including the opposite-facing-twin head-connection pad of the third plurality of opposite-facing-twin head-connection pads of the opposite-facing-twin head-slider 105a and a matching opposite-facing-twin head-connection pad of the fourth plurality of opposite-facing-twin head-connection pads of the opposite-facing-twin lead-suspension 230a. Thus, in accordance with embodiments of the present invention, the opposite-facing-twin solder joint may be formed between the opposite-facing-twin pair of opposite-facing-twin head-connection pads, similarly to the manner in which solder joint 410c-1 is formed between the pair of head-connection pads 401b-11 and 401b-21, previously described. The preceding laser soldering operations may be summarized in flowcharts of a method, which are next described.

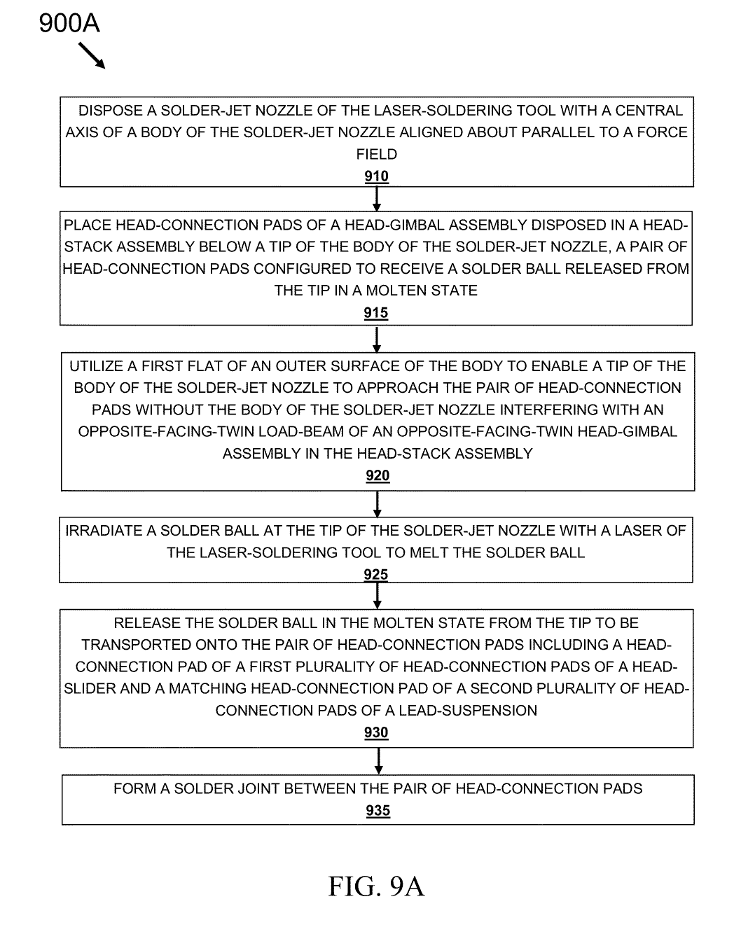

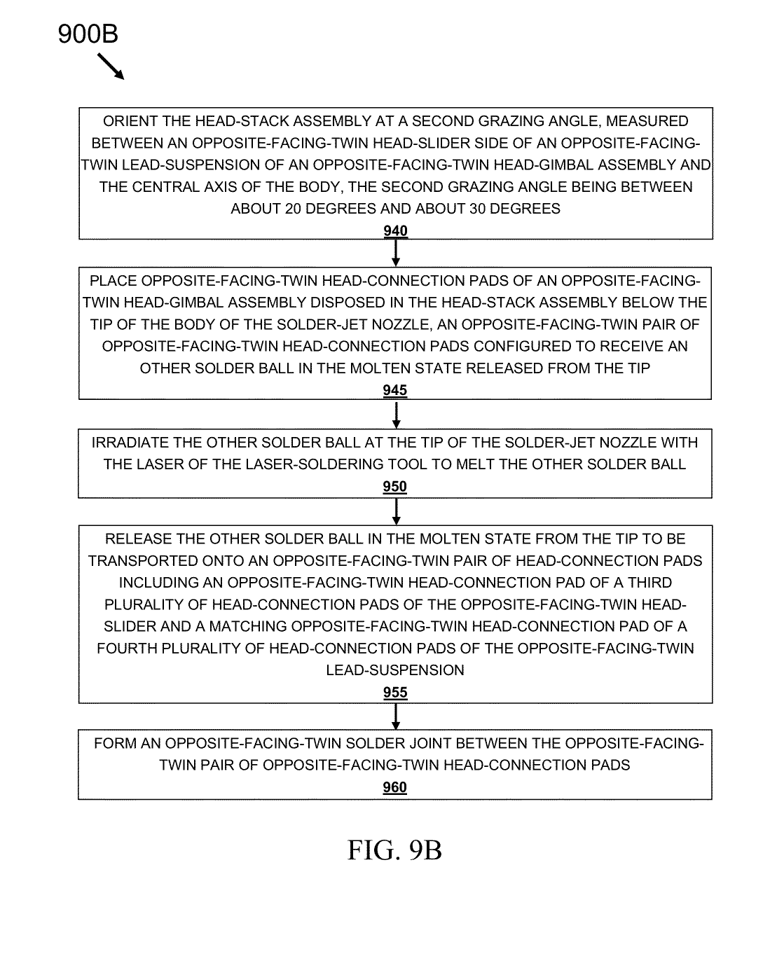

With reference now to FIG. 9A, in accordance with an embodiment of the present invention, a flowchart 900A is shown of a method for laser-soldering head-connection pads of a HSA for a hard-disk drive with a laser-soldering tool. The method includes the following operations. At 910, a solder-jet nozzle of the laser-soldering tool is disposed with a central axis of a body of the solder-jet nozzle aligned about parallel to a force field. The force field may be a gravitational force field of the Earth. Thus, releasing the solder ball in a molten state from the tip to be transported onto the pair of head-connection pads may include dropping the solder ball in a molten state from the tip to fall onto the pair of head-connection pads. At 915, head-connection pads of a HGA disposed in a HSA are placed below a tip of the body of the solder-jet nozzle with a pair of head-connection pads configured to receive a solder ball released from the tip in a molten state. In addition, prior to operation 915, the lead-suspension of HGA disposed in a HSA may be oriented at a grazing angle, measured between a head-slider side of the lead-suspension of HGA and the central axis of the body, the grazing angle being between about 20 degrees and about 30 degrees. Thus, the solder-jet nozzle may be disposed within about 100 microns (μm) of a joint of the head-connection pads. At 920, a first flat of an outer surface of the body is utilized to enable a tip of the body of the solder-jet nozzle to approach the pair of head-connection pads without the body of the solder-jet nozzle interfering with an opposite-facing-twin load-beam of an opposite-facing-twin HGA in the HSA. At 925, a solder ball is irradiated at the tip of the solder-jet nozzle with a laser of the laser-soldering tool to melt the solder ball. At 930, the solder ball is released in the molten state from the tip to be transported onto the pair of head-connection pads including a head-connection pad of a first plurality of head-connection pads of a head-slider and a matching head-connection pad of a second plurality of head-connection pads of the lead-suspension. At 935, a solder joint is formed between the pair of head-connection pads.

With reference now to FIG. 9B, in accordance with an embodiment of the present invention, a flowchart 900B is shown of further operations in a method for laser-soldering head-connection pads of a HSA for a hard-disk drive with a laser-soldering tool. The method further includes the following operations. At 940, the HSA is oriented at a second grazing angle, measured between an opposite-facing-twin head-slider side of an opposite-facing-twin lead-suspension of an opposite-facing-twin HGA and the central axis of the body, the second grazing angle being between about 20 degrees and about 30 degrees. At 945, opposite-facing-twin head-connection pads of the opposite-facing-twin HGA disposed in the HSA are placed below the tip of the body of the solder-jet nozzle with the opposite-facing-twin pair of opposite-facing-twin head-connection pads configured to receive an other solder ball in the molten state released from the tip. As the opposite-facing-twin lead-suspension of the opposite-facing-twin HGA of the HSA is disposed about parallel to and opposite to the lead-suspension of the HGA of the HSA, a second flat of the outer surface of the body may similarly be utilized to enable the tip of the body to approach opposite-facing-twin head-connection pads within a distance at which delivery of the other solder ball may be made to the opposite-facing-twin head-connection pads, without the body interfering with a load-beam of the HGA in the HSA. At 950, the other solder ball is irradiated at the tip of the solder-jet nozzle with the laser of the laser-soldering tool to melt the other solder ball. At 955, the other solder ball is released in the molten state from the tip to be transported onto an opposite-facing-twin pair of opposite-facing-twin head-connection pads including an opposite-facing-twin head-connection pad of a third plurality of opposite-facing-twin head-connection pads of the opposite-facing-twin head-slider and a matching opposite-facing-twin head-connection pad of a fourth plurality of opposite-facing-twin head-connection pads of the opposite-facing-twin lead-suspension. At 960, the opposite-facing-twin solder joint is formed between the opposite-facing-twin pair of opposite-facing-twin head-connection pads.

Embodiments of the present invention, described herein, may prove useful at least for the following reasons. Embodiments of the present invention provide a production process in which the head-connection pads of a HGA are joined at the HSA level. Therefore, embodiments of the present invention may achieve a reduction in HSA production costs. Moreover, in the event of a defect in a magnetic-recording head is discovered by a HDD test process, embodiments of the present invention facilitate replacement of the defective magnetic-recording head, without recourse to replacement of the entire HGA. Therefore, embodiments of the present invention may reduce the amount of rework to replace the defective magnetic-recording head, and may further reduce scrap costs associated with scrapping a lead-suspension to which the magnetic-recording head is attached. Furthermore, embodiments of the present invention can be applied to a head-slider in-situ while disposed in the HSA, and consequently may reduce the risk of damage to the magnetic-recording head through adventitious electrostatic discharge (ESD) that might occur in handling discrete components, such as individual HGAs. Additionally, embodiments of the present invention may increase the yield of HSAs at quasi-static electrical testing of the HSAs.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. For example, for purposes of convenience and clarity of the preceding description, HGAs including top head-sliders and the component parts thereof have been referred to with the term of art, “opposite-facing-twin.” However, embodiments of the present invention that are recited in the claims may refer to both the case, as per the preceding description, in which a HGA including a top head-slider is taken as an “opposite-facing-twin HGA” and a HGA including a bottom head-slider is referred to as simply the “HGA,” and the case in which a HGA including a bottom head-slider is referred to as an “opposite-facing-twin HGA” and a HGA including a top head-slider is referred to as simply the “HGA.” Therefore, it is intended that the scope of the invention be defined by the claims appended hereto and their equivalents.

What is claimed is:

1. A solder-jet nozzle for laser-soldering head-connection pads of a head-stack assembly for a hard-disk drive, said solder-jet nozzle comprising:
a body including a tip, said tip disposed at a distal end of said body configured to deliver a solder ball in proximity to head-connection pads of a head-gimbal assembly that is disposed in said head-stack assembly;
a central duct disposed along a central axis of said body, and configured to convey said solder ball to said tip; and
an outer surface of said body comprising:
a first portion substantially coinciding with portions of a conical surface of a cone, an axis of said cone disposed about along said central axis of said body; and
at least a first flat contiguous with said first portion, disposed about parallel to said central axis of said body, and intersecting said conical surface of said cone.

2. The solder-jet nozzle of claim 1, wherein said first flat is disposed to allow orientation of said solder-jet nozzle at an upper limit of a grazing angle, measured between a head-slider side of a lead-suspension of said head-gimbal assembly and said central axis of said body, said upper limit of said grazing angle greater than a lesser upper limit of a lesser grazing angle of a first-flat-less solder-jet nozzle without said first flat.

3. The solder-jet nozzle of claim 2, wherein said grazing angle is equal to or greater than about 30 degrees.

4. The solder-jet nozzle of claim 1, wherein an opening angle of said cone is between about 15 degrees and about 20 degrees.

5. The solder-jet nozzle of claim 1, wherein said first flat is configured to enable a tip of said body to approach said head-connection pads within a distance at which delivery of said solder ball may be made to said head-connection pads, without said body interfering with an opposite-facing-twin load-beam of an opposite-facing-twin head-gimbal assembly in said head-stack assembly.

6. The solder-jet nozzle of claim 5, wherein said first flat is configured to enable said tip of said body to approach said head-connection pads more closely than a tip of a first-flat-less solder-jet nozzle without said first flat.

7. The solder-jet nozzle of claim 1, wherein said outer surface of said body further comprises a second flat disposed on an opposite side of said body to where said first flat is disposed, said second flat contiguous with said first portion, disposed about parallel to said central axis of said body, and intersecting said conical surface of said cone.

8. The solder-jet nozzle of claim 1, wherein said outer surface of said body further comprises a second portion defining at least a portion of an outer surface of said tip, said second portion substantially coinciding with portions of a second conical surface of a second cone, an axis of said second cone disposed about along said central axis of said body.

9. The solder-jet nozzle of claim 8, wherein said second cone has a second opening angle greater than an opening angle of said cone associated with said first portion.

10. The solder-jet nozzle of claim 8, wherein a second opening angle of said second cone associated with said second portion is about 40 degrees.

11. The solder-jet nozzle of claim 8, wherein an end surface of said tip is chamfered.

12. A laser-soldering tool for laser-soldering head-connection pads of a head-stack assembly for a hard-disk drive, said laser-soldering tool comprising:
a laser; and
a solder-jet nozzle comprising:
a body including a tip, said tip disposed at a distal end of said body configured to deliver a solder ball in proximity to said head-connection pads of a head-gimbal assembly that is disposed in said head-stack assembly;
a central duct disposed along a central axis of said body, and configured to convey said solder ball to said tip; and
an outer surface of said body comprising:
a first portion substantially coinciding with portions of a conical surface of a cone, an axis of said cone disposed about along said central axis of said body; and
at least a first flat contiguous with said first portion, disposed about parallel to said central axis of said body, and intersecting said conical surface of said cone; and
wherein said laser is configured to melt said solder ball disposed at said tip.

13. The laser-soldering tool of claim 12, wherein said solder-jet nozzle is configured to be disposed within about 100 microns (μm) of a joint of said head-connection pads.

14. The laser-soldering tool of claim 12, wherein said solder-jet nozzle and said laser are configured to solder together a pair of head-connection pads of said head-gimbal assembly disposed in said head-stack assembly by forming a solder joint between said pair of head-connection pads, said pair of head-connection pads comprising a head-connection pad of a first plurality of head-connection pads of a head-slider and a matching head-connection pad of a second plurality of head-connection pads on a lead-suspension.

15. The laser-soldering tool of claim 12, wherein a paraxial ray of a beam of light from said laser is configured to lie within said central duct and about along said central axis of said body.

16. The laser-soldering tool of claim 12, wherein said outer surface of said body further comprises a second flat disposed on an opposite side of said body to where said first flat is disposed, said second flat contiguous with said first portion, disposed about parallel to said central axis of said body, and intersecting said conical surface of said cone.

17. The laser-soldering tool of claim 16, wherein said solder-jet nozzle and said laser are configured to solder together an opposite-facing-twin pair of opposite-facing-twin head-connection pads of an opposite-facing-twin head-gimbal assembly disposed in said head-stack assembly by forming a solder joint between said opposite-facing-twin pair of opposite-facing-twin head-connection pads, said opposite-facing-twin pair of opposite-facing-twin head-connection pads comprising an opposite-facing-twin head-connection pad of a third plurality of opposite-facing-twin head-connection pads of an opposite-facing-twin head-slider and a matching opposite-facing-twin head-connection pad of a fourth plurality of opposite-facing-twin head-connection pads on an opposite-facing-twin lead-suspension,
wherein said opposite-facing-twin lead-suspension of said opposite-facing-twin head-gimbal assembly is disposed opposite to a lead-suspension of said head-gimbal assembly.

18. The laser-soldering tool of claim 12, said first flat is disposed to allow orientation of said solder-jet nozzle at an upper limit of a grazing angle, measured between a head-slider side of a lead-suspension of said head-gimbal assembly and said central axis of said body, said upper limit of said grazing angle greater than a lesser upper limit of a lesser grazing angle of a first-flat-less solder-jet nozzle without said first flat.

19. The laser-soldering tool of claim 18, said first flat is configured to enable a tip of said body to approach said head-connection pads within a distance at which delivery of said solder ball may be made to said head-connection pads, without said body interfering with an opposite-facing-twin load-beam of an opposite-facing-twin head-gimbal assembly in said head-stack assembly.

20. A method for laser-soldering head-connection pads of a head-stack assembly for a hard-disk drive with a laser-soldering tool, said method comprising:
disposing a solder-jet nozzle of said laser-soldering tool with a central axis of a body of said solder-jet nozzle aligned about parallel to a force field;
placing head-connection pads of a head-gimbal assembly disposed in a head-stack assembly below a tip of said body of said solder-jet nozzle, a pair of head-connection pads configured to receive a solder ball released from said tip in a molten state;
irradiating a solder ball at said tip of said solder-jet nozzle with a laser of said laser-soldering tool to melt said solder ball;
releasing said solder ball in said molten state from said tip to be transported onto said pair of head-connection pads comprising a head-connection pad of a first plurality of head-connection pads of a head-slider and a matching head-connection pad of a second plurality of head-connection pads of a lead-suspension; and
forming a solder joint between said pair of head-connection pads; and
wherein a first flat of an outer surface of said body enables a tip of said body of said solder-jet nozzle to approach said pair of head-connection pads without said body of said solder-jet nozzle interfering with an opposite-facing-twin load-beam of an opposite-facing-twin head-gimbal assembly in said head-stack assembly.

21. The method of claim 20, wherein said force field is a gravitational force field; and
wherein said releasing said solder ball in a molten state from said tip to be transported onto said pair of head-connection pads comprises dropping said solder ball in a molten state from said tip to fall onto said pair of head-connection pads.

22. The method of claim 20, further comprising:
orienting said lead-suspension of said head-gimbal assembly disposed in a head-stack assembly at a grazing angle, measured between a head-slider side of said lead-suspension of said head-gimbal assembly and said central axis of said body, said grazing angle being between about 20 degrees and about 30 degrees.

23. The method of claim 20, further comprising:
orienting said head-stack assembly at a second grazing angle, measured between an opposite-facing-twin head-slider side of an opposite-facing-twin lead-suspension of an opposite-facing-twin head-gimbal assembly and said central axis of said body, said second grazing angle being between about 20 degrees and about 30 degrees; and
placing opposite-facing-twin head-connection pads of an opposite-facing-twin head-gimbal assembly disposed in said head-stack assembly below said tip of said body of said solder-jet nozzle, an opposite-facing-twin pair of opposite-facing-twin head-connection pads configured to receive an other solder ball in said molten state released from said tip.

24. The method of claim 23, further comprising:
irradiating said other solder ball at said tip of said solder-jet nozzle with said laser of said laser-soldering tool to melt said other solder ball;
releasing said other solder ball in said molten state from said tip to be transported onto an opposite-facing-twin pair of opposite-facing-twin head-connection pads comprising an opposite-facing-twin head-connection pad of a third plurality of opposite-facing-twin head-connection pads of said opposite-facing-twin head-slider and a matching opposite-facing-twin head-connection pad of a fourth plurality of opposite-facing-twin head-connection pads of said opposite-facing-twin lead-suspension; and
forming an opposite-facing-twin solder joint between said opposite-facing-twin pair of opposite-facing-twin head-connection pads.

25. The method of claim 20, further comprising:
disposing said solder-jet nozzle within about 100 microns (μm) of a joint of said head-connection pads.
